(19) United States
(12) Patent Application Publication
(10) Pub. No.: US 2010/0220222 A1
(43) Pub. Date: Sep. 2, 2010

(54) IMAGE PROCESSING DEVICE, IMAGE PROCESSING METHOD, AND RECORDING MEDIUM STORING IMAGE PROCESSING PROGRAM

(75) Inventor: Yukihiro NAITO, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Olympus Corporation, Tokyo (JP)

(21) Appl. No.: 12/710,476

(22) Filed: Feb. 23, 2010

(30) Foreign Application Priority Data
Feb. 26, 2009 (JP) 2009-044877

(51) Int. Cl. H04N 5/217

(52) U.S. Cl. 348/241; 348/E05.078

(57) ABSTRACT

A noise-level determining unit estimates the noise level of each pixel or each predetermined region formed of multiple pixels in at least one image among multiple images; a combining ratio determining unit determines, for each pixel or each region, a combining ratio on the basis of the noise level; and a weighted-averaging processing unit generates a combined image from the multiple images on the basis of the combining ratio.

### BACKGROUND OF THE INVENTION

1. Field of the Invention

The present invention relates to an image processing apparatus, an image processing method, a image processing program, and a storage medium in which an image processing program is stored and, more specifically, relates to an image processing apparatus, an image processing program, and a storage medium in which an image processing program is stored that combine images using multiple time-sequentially acquired images.

2. Description of Related Art

To acquire an image with a low level of noise when acquiring a still image with an image acquisition apparatus, such as a digital camera, it is effective to ensure sufficient exposure time. However, extending the exposure time causes a problem in that the image becomes unclear due to blurriness in the image caused by camera shaking by vibration of the hands and movement of the subject.

As a method of counteracting such blurriness, an electronic blur correction method has been proposed. For example, Japanese Unexamined Patent Application, Publication No. HEI-9-261526 discloses an invention for acquiring a satisfactory image without blurriness by continuously carrying out image acquisition multiple times with a short exposure time for which blurriness is low, align the multiple images such that movement in the images is cancelled out, and then carrying out combining processing.

To suppress this artifact, Japanese Unexamined Patent Application, Publication No. 2002-290817 discloses an invention for calculating difference values between corresponding pixels before carrying out addition processing (averaging processing) by combining processing; and when the difference value is larger than or equal to a threshold, it is determined that alignment processing has failed, and combining processing is not carried out. Japanese Unexamined Patent Application, Publication No. 2008-99260 discloses an invention for adjusting the weight for weighted averaging processing of combining processing on the basis of the difference value between corresponding pixels.

Furthermore, there is a fixed relationship between the amount of noise contained in a pixel output from an image acquisition device and the pixel value itself, and it is known that the amount of noise can be estimated from the pixel value. In many cases, gradation conversion processing, etc., is carried out on pixel values output from the image acquisition device during image processing described below, and, typically, gamma characteristic gradation conversion processing that enhances dark sections and suppresses bright sections is carried out. As a result, images on which image processing is carried out contain different levels of noise depending on the pixel values. Since the reason for combining multiple images in electronic blur correction is to reduce noise, the appropriate number of images to be used in combining should be determined on the basis of the amount of noise.

### BRIEF SUMMARY OF THE INVENTION

The present invention provides an image processing apparatus that is capable of alleviating artifacts, such as fuzziness and/or a double image, through electronic blur correction for reducing blurriness by carrying out combining processing after aligning multiple images.

A first aspect of the present invention is an image processing apparatus configured to acquire multiple images of a subject by carrying out image acquisition of the subject and generate a combined image by combining the acquired multiple images, the apparatus including a noise-level estimating unit configured to estimate a noise level of each pixel or each predetermined region formed of multiple pixels in at least one image of the multiple images; a combining ratio determining unit configured to determine, on the basis of the noise level, a combining ratio of a target image with respect to a reference image for each pixel or each region, when one of the multiple images is the reference image and the other images are target images; and a combining unit configured to generate a combined image by combining the multiple images on the basis of the combining ratio.

A second aspect of the present invention is an image processing method of acquiring multiple images and generating a combined image by combining the acquired multiple images, the method including a noise-level estimating step of estimating a noise level of each pixel or each predetermined region formed of multiple pixels in at least one image of the multiple images; a combining ratio determining step of determining, on the basis of the noise level, a combining ratio of a target image with respect to a reference image for each pixel or each region, when one of the multiple images is the reference image and the other images are target images; and a combining step of generating a combined image by combining the multiple images on the basis of the combining ratio.

The third aspect of the present invention is a program storage medium on which is stored an image processing program instructing a computer to execute image processing of acquiring multiple images and generating a combined image by combining the acquired multiple images, the image processing including a noise-level estimating step of estimating a noise level of each pixel or each predetermined region formed of multiple pixels in at least one image of the multiple images; a combining ratio determining step of determining, on the basis of the noise level, a combining ratio of a target image with respect to a reference image for each pixel or the each region, when one of the multiple images is the reference image and the other images are target images; and a combining step of generating a combined image by combining the multiple images on the basis of the combining ratio.

According to the above-described aspects, artifacts, such as the occurrence of fuzziness and/or a double image, due to excess combining processing carried out on pixels or regions with low levels of noise can be suppressed.

### BRIEF DESCRIPTION OF THE SEVERAL VIEWS OF THE DRAWINGS

FIG. 1 is a block diagram illustrating, in outline, an image processing apparatus according to a first embodiment of the present invention.

FIG. 2 is a schematic view illustrating the flow of acquiring one image by combining four images.

FIG. 3 is a block diagram illustrating, in outline, a combining processing unit according to the first embodiment of the present invention.

FIG. 4 is a diagram illustrating the relationship between pixel values output from an image acquisition device and the amount of noise.

FIG. 5 is a diagram illustrating the relationship between pixel values and the amount of noise after gradation conversion processing is carried out.

FIG. 6 is a block diagram illustrating, in outline, a noise-level estimating unit according to the first embodiment of the present invention.

FIG. 7 is a block diagram illustrating, in outline, the noise-level estimating unit according to the first embodiment of the present invention.

FIG. 8 is a diagram illustrating the relationship between noise level and combining ratio.

FIG. 9 is a block diagram illustrating, in outline, a combining processing unit according to a second embodiment of the present invention.

FIG. 10 is a diagram illustrating the relationship between noise level and combining ratio according to the second embodiment of the present invention.

FIG. 11 is a diagram illustrating the relationship between noise level and combining ratio according to the second embodiment of the present invention.

FIG. 12 is a block diagram illustrating, in outline, a combining processing unit according to a third embodiment of the present invention.

FIG. 13 is diagram illustrating the relationship between absolute difference values of pixels in the combining processing unit, combining ratio, and thresholds according to the third embodiment of the present invention.

### DETAILED DESCRIPTION OF THE INVENTION

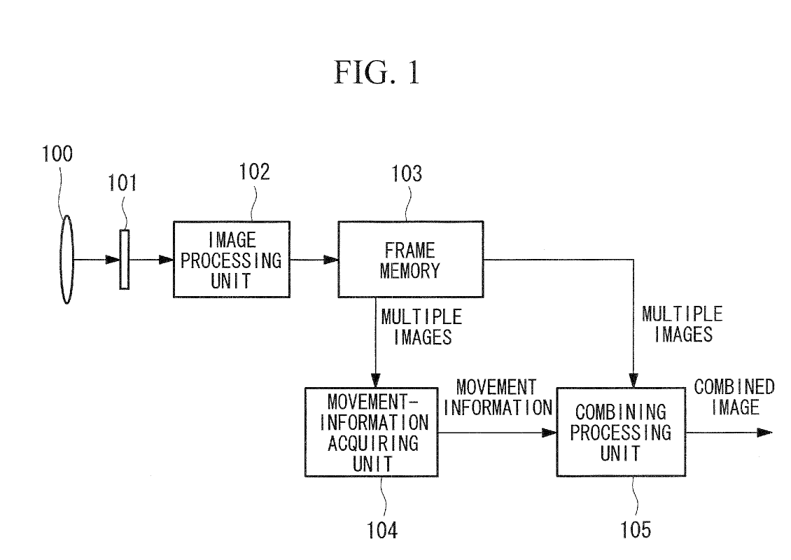

Embodiments of an image processing apparatus according to the present invention will be described below with reference to the drawings. FIG. 1 is a block diagram illustrating, in outline, an image processing apparatus according to a first embodiment of the present invention.

As illustrated in FIG. 1, the image processing apparatus according to this embodiment includes an optical system 100, an image acquisition device 101, an image processing unit 102, a frame memory 103, a movement-information acquiring unit 104, and a combining processing unit 105.

The optical system 100 is constituted of lenses, etc., forms an image of a subject, and is positioned such that an image is formed on the image acquisition device 101. The image acquisition device 101 generates an image-acquisition signal, which is electrical image information, on the basis of the image of the subject formed by the optical system 100 and outputs the image-acquisition signal to the image processing unit 102. The image processing unit 102 carries out image processing, such as color processing and gradation conversion processing, on the image-acquisition signal input from the image acquisition device 101. The frame memory 103 is where images processed in a predetermined manner by the image processing unit 102 are stored.

The movement-information acquiring unit 104 outputs movement among multiple images stored in the frame memory 103 as movement information. The movement-information acquiring unit 104 sets one of the multiple images stored in the frame memory 103 as a reference image used as a reference when image combining processing is carried out and defines a target image that is compared with the reference image and is subjected to image combining processing. Then, one set of vector information, containing a horizontal movement amount and a vertical movement amount corresponding to the movement of the target image relative to the reference image is output as movement information of the target image. The movement information may not only be one set of vector information corresponding to one image but may instead be obtained by calculating vector information of regions defined by dividing an image into a plurality of regions or may be obtained by calculating vector information for each pixel. Furthermore, an amount of movement by rotation or an amount of change due to expansion or contraction may be defined as movement information. Moreover, movement information is not only obtained through calculation but may instead be acquired by a sensor, such as a gyro, provided inside the apparatus.

The combining processing unit 105 corrects the target image stored in the frame memory 103 on the basis of the movement information acquired by the movement-information acquiring unit 104, combines the reference image with the corrected target image, and outputs this as a combined image.

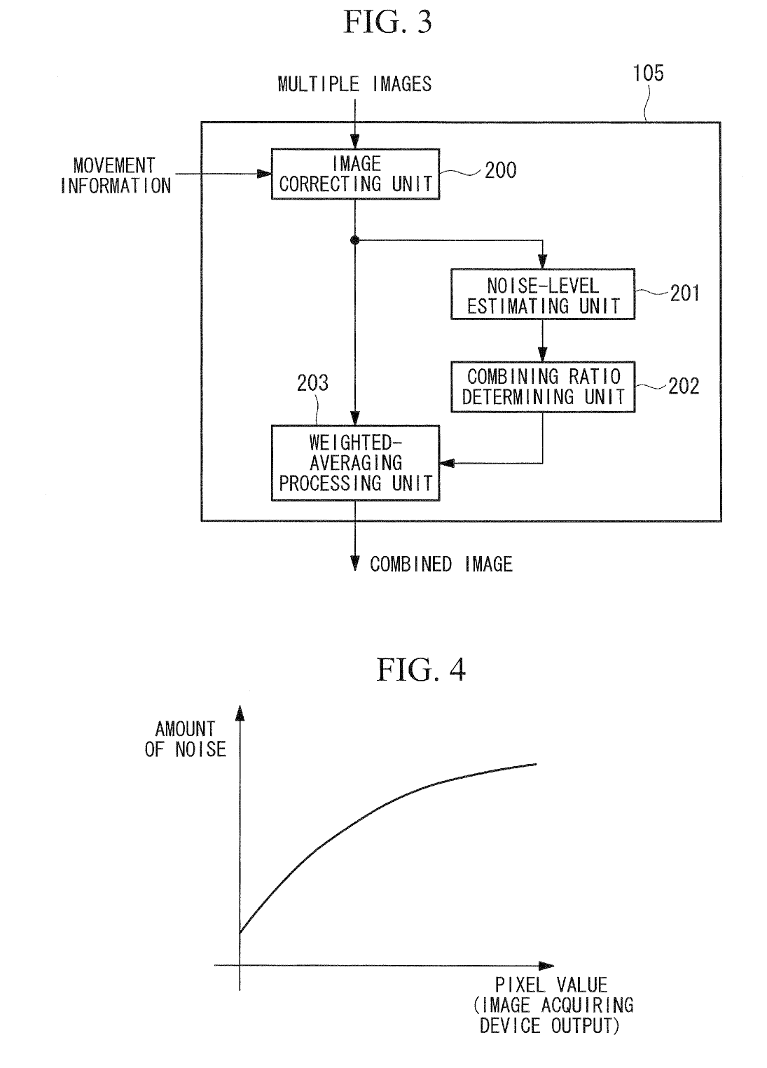

The configuration of the combining processing unit 105 will be described below. FIG. 3 is a block diagram illustrating the configuration of the combining processing unit 105. As illustrated in FIG. 3, the combining processing unit 105 includes an image correcting unit 200, a noise-level estimating unit 201, a combining ratio determining unit 202, and a weighted-averaging processing unit 203.

The image correcting unit 200 corrects the target image on the basis of movement information output from the movement-information acquiring unit 104. In this embodiment, the position of the target image is shifted to be aligned with the reference image on the basis of vector information containing a horizontal movement amount and a vertical movement amount. The pixel values of the reference image and the pixel values of the aligned target image are output to the noise-level estimating unit 201. When the movement information includes, for example, information related to rotation or expansion and contraction, correction processing equivalent to rotation or expansion and contraction is carried out at the image correcting unit 200 to align the reference image and the target image.

As illustrated in FIG. 6, the noise-level estimating unit 201 includes a noise-level calculating unit 300 that calculates the noise level of the reference image, a noise-level calculating unit 301 that calculates the noise level of the target image, and a maximum-value calculating unit 302 and estimates the intensity of noise (noise level) in the target pixel on which combining processing is carried out.

In general, there is a fixed relationship between the amount of noise contained in a pixel output from the image acquisition device and the pixel value, and it is known that the amount of noise can be estimated from a pixel value. FIG. 4 illustrates a typical relationship between a pixel value output from the image acquisition device and the amount of noise. In FIG. 4, the horizontal axis represents pixel values of pixels output from the image acquisition device, whereas the vertical axis represents the amount of noise (standard deviation of noise, etc.) contained in those pixels. Typically, as the pixel value output from the image acquisition device increases, the amount of noise tends to increase.

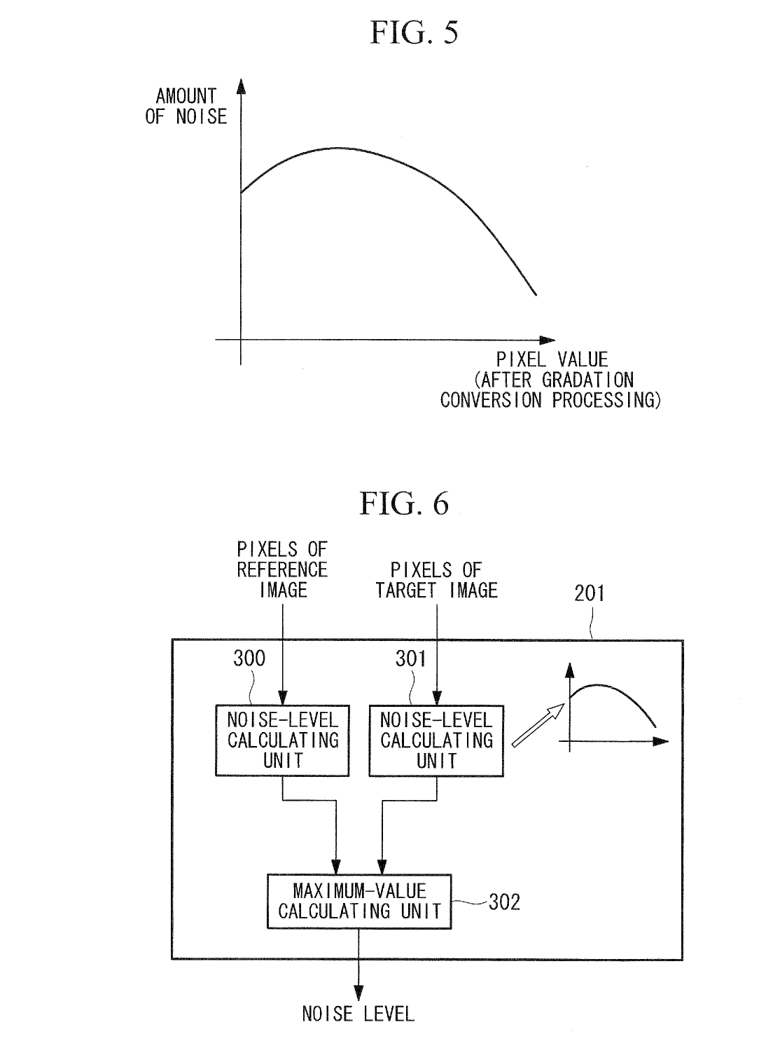

Usually, image processing, such as gradation conversion, is often carried out on an image acquired by the image acquisition device, and, as gradation conversion processing, gamma characteristic gradation conversion processing that enhances dark sections and suppresses bright sections is carried out. FIG. 5 illustrates a typical relationship between pixel values and the amount of noise after gradation conversion processing is carried out. As a result of noise being amplified in regions with small pixel values and suppressed in regions with large pixel values, a typical relationship such as that illustrated in FIG. 5 is obtained.

Therefore, the noise-level calculating units 300 and 301 have information indicating the relationship between the pixel values and the amount of noise illustrated in FIG. 5. Then, the noise-level calculating unit 300 calculates the noise level of each pixel in the reference image on the basis of the relationship between the pixel values and the amount of noise in FIG. 5 and the pixel values of the reference image input from the image correcting unit 200. Similarly, the noise-level calculating unit 301 calculates the noise level of each pixel in the aligned target image on the basis of the relationship between the pixel values and the amount of noise in FIG. 5 and the pixel values of the aligned target image input from the image correcting unit 200.

The information indicating the relationship between the pixel values and the amount of noise may be acquired by, for example, piecewise linear approximation or methods such as creating a table. Furthermore, calculation of the noise level may be carried out on all pixels in the reference image or the target image or on each predetermined region.

The maximum-value calculating unit 302 calculates the maximum value of the noise level on the basis of the noise level calculated at the noise-level calculating units 300 and 301.

For the pixels at which the reference image and the target image are aligned successfully, the pixel values of the reference image and the pixel values of the target image do not differ greatly, and thus the calculated noise levels also do not differ greatly. However, for pixels at which alignment is unsuccessful, there is a high possibility that such values differ greatly. Therefore, the maximum value is selected by the maximum-value calculating unit 302, and this value is set as the noise level of the respective pixels.

In this embodiment, the maximum-value calculating unit 302 sets the maximum value among the noise level of the reference image and the noise level of the target image as the noise level. Instead, however, it is possible to set the weighted average value of the noise level of the reference image and the noise level of the target image as the noise level or, for example, to estimate the noise level by weighting the pixels of the reference image.

The combining ratio determining unit 202 determines the combining ratio of the pixel of the target image to the pixel of the reference image according to the noise level output from the noise-level estimating unit 201 and outputs this combining ratio to the weighted-averaging processing unit 203. The combining ratio is determined on the basis of information indicating the relationship between the noise level and the combining ratio, such as that illustrated in FIG. 8, that is defined in advance piecewise linear approximation or a method such as creating a table. Here, for the combining ratio, the combining percentage of the target image is represented by a value between 0.0 and 1.0 when the reference image is 1.0. With the example illustrated in FIG. 8, the combining ratio is set in proportion to the magnitude of the noise level. In other words, the combining ratio of a pixel with a high noise level is close to 1.0 since the need to reduce noise by combining is high, whereas the combining ratio of a pixel with a low noise level is kept at approximately 0.5 since it is less likely that noise needs to be reduced, and, with such a setting, the risk of generating an artifact is reduced. For example, when the need to reduce noise by combining is lower, it is possible to set the combining ratio to less than 0.5, and when the lower limit value of the combining ratio is set to 0.0, combining processing is not carried out on the pixels of the target image as a result.

By carrying out broken line approximation on or creating a table of a relationship that integrates the relationship used by the noise-level calculating units 300 and 301 and the relationship illustrated in FIG. 8, the combining ratio may be directly derived from the pixel values that are input to the noise-level estimating unit 201.

The weighted-averaging processing unit 203 carries out weighted averaging processing between the pixels of the reference image and the pixels of the target image on the basis of the combining ratio output from the combining ratio determining unit 202 and sets these as the pixels of the combined image.

Next, an image processing method performed by the image processing apparatus having the above-described configuration will be described.

In this embodiment an example is described in which one combined image is formed by carrying out separate exposures four times i.e., processing for acquiring an image is carried out four times, in one image acquisition, and repeating basic processing for generating one combined image from two images three times, where a maximum of four images are subjected to the combining processing.

When an image of the subject is acquired, the image formed by the optical system 100 is converted into an image-acquisition signal by the image acquisition device 101 and is output to the image processing unit 102. The image processing unit 102 carries out predetermined image processing, such as color processing and harmony conversion processing, on the input image-acquisition signal, and the signal is output to the frame memory 3 as image data on which combining processing can be carried out at the combining processing unit 105. The above-described image acquisition processing by the optical system 100, the image acquisition device 101, and the image processing unit 102 is repeated four times, and four sets of image data (frames 1 to 4) on which the predetermined image processing has been carried out are stored in the frame memory 103.

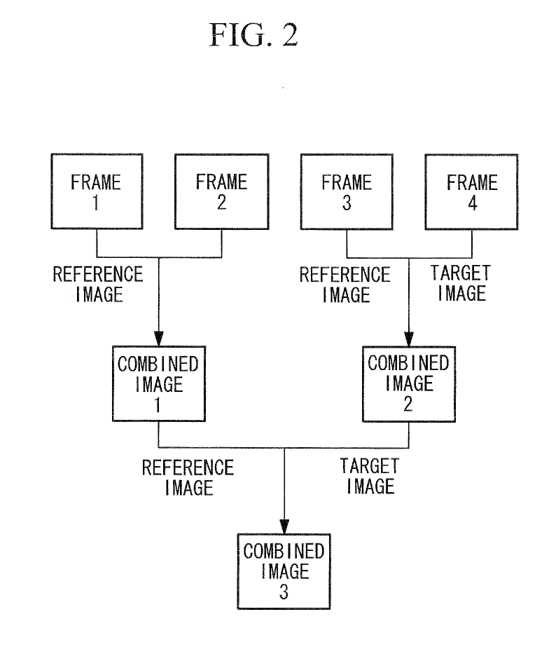

As shown in FIG. 2, a combined image 1 is generated from frames 1 and 2, a combined image 2 is generated from frames 3 and 4, and finally one combined image is formed from the combined images 1 and 2.

First, the processing for generating the combined image 1 by combining frames 1 and 2, where frame 1 is the reference image and frame 2 is the target image, is described.

Frame 1, which is the reference image, and frame 2, which is the target image, are compared at the movement-information acquiring unit 104, and movement information of frames 1 and 2 is computed from the horizontal movement amount and the vertical movement amount between both frames. The movement information is output to the image correcting unit 200 of the combining processing unit 105. The image correcting unit 200 receives the movement information input from the movement-information acquiring unit 104 and frames 1 and 2 from the frame memory 103.

Then, the image correcting unit 200 aligns frames 1 and 2 by shifting the position of frame 2 on the basis of the movement information input from the movement-information acquiring unit 104. Frame 1 and aligned frame 2 are output to the noise-level calculating units 300 and 301, respectively, of the noise-level estimating unit 201.

The noise-level calculating unit 300 computes the noise levels of the pixels in frame 1 on the basis of the relationship between the pixel values and the amounts of noise defined in advance. Similarly, the noise-level calculating unit 301 computes the noise levels of the pixels in aligned frame 2. The computation results of the noise-level calculating units 300 and 301 are output to the maximum-value calculating unit 302.

The maximum-value calculating unit 302 compares the noise level of each pixel in frame 1 and the noise level of each pixel in aligned frame 2, determines from the difference of the noise levels whether or not the alignment of frame 2 with respect to frame 1 is successful, and thereby estimates the noise level. In other words, the noise levels of two pixels for which the alignment of frame 2 is successful do not differ. However, it is more likely that the noise levels of pixels for which the alignment is unsuccessful differ. In such a case, by selecting the higher noise level, this noise level is set as the noise level of those pixels. The determined noise level is output to the combining ratio determining unit 202.

The combining ratio determining unit 202 determines the combining ratio of the pixels in frame 2 with respect to the pixels in frame 1 on the basis of the noise levels input from the noise-level calculating units 300 and 301 and the relationship of the noise level and the combining ratio defined in advance. The determined combining ratio is output to the weighted-averaging processing unit 203. The weighted-averaging processing unit 203 carries out weighted averaging processing on frames 1 and 2 on the basis of the input combining ratio and generates combined image 1.

The same combining processing is carried out on frames 3 and 4. In other words, frame 3, which is the reference image, and frame 4, which is the target image, are combined to generate combined image 2. Subsequently, a combined image 3 is generated from combined image 1 generated from frames 1 and 2, which is the reference image, and combined image 2 generated from frames 3 and 4, which is the target image.

As described above, according to this embodiment, by estimating the noise levels of pixels that are targets of combining processing by the noise-level estimating unit 201 and controlling the combining ratio in accordance with the estimated noise levels, it is possible to suppress artifacts, such as the occurrence of fuzziness and/or a double image, due to excess combining processing carried out on pixels or regions with low levels of noise, and thus, a satisfactory combining result is achieved. Furthermore, by estimating the noise levels for the pixels in the reference image and the pixels in the target image and calculating the final noise level from these results, it is possible to estimate the noise level even more precisely.

In this embodiment, alignment of pixels by the movement-information acquiring unit 104 is described. However, if frame rate at the time of image acquisition is sufficiently high, the amount of change among the pixels is small, and thus it is possible to omit the alignment processing. Moreover, with this embodiment, estimation of the noise level and determination of the combining ratio is carried out pixelwise. Instead, however, the estimation processing of the noise level and the determination processing of the combining ratio may each be carried out once for a region formed of multiple pixels to reduce the amount of computation.

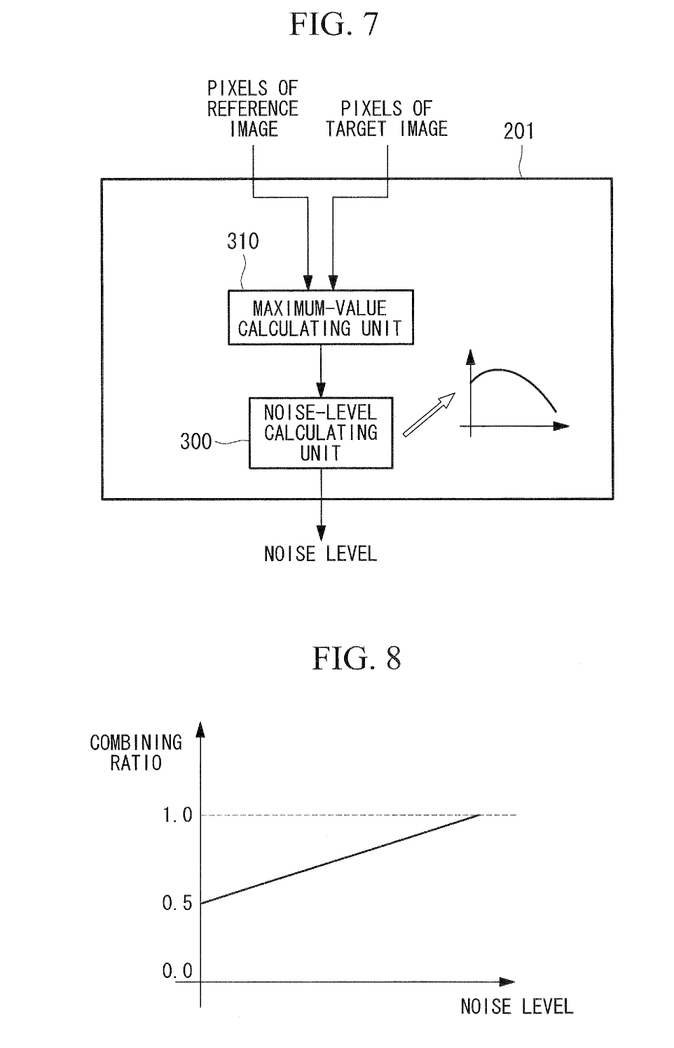

Furthermore, when it is undesirable from the viewpoint of the amount of computation to operate a plurality of noise-level calculating units 300 and 301, as illustrated in FIG. 7, the minimum pixel value of the pixels in the reference image and the pixels in the target image may be calculated at a minimum-value calculating unit 310, the noise-level calculating unit 300 may calculate the noise level on the basis of this minimum value, and this may be set as the final noise level. In such a case, if the characteristic is such that when the amount of noise increases when the pixel value is small, and the amount of noise decreases when the pixel value is large, substantially the same result as that of the configuration in FIG. 6 can be obtained. As illustrated in FIG. 7, the minimum-value calculating unit 310 selects the minimum value. Instead, however, a maximum value or a weighted average value may be calculated and set as a representative value, and then this representative value may be used to carry out calculation at the noise-level calculating unit 300. In this way, by calculating a representative value according to the characteristic and estimating the noise level from the representative value, without estimating the noise level for each of the pixels in the reference image and each of the pixels in the target image, it is possible to reduce the amount of computation required for noise level estimation.

Furthermore, the combining processing of multiple images is not limited thereto, and, for example, combined image 1 and frame 3, which are illustrated in FIG. 2, may be combined, and this combining result and frame 4 may be combined. Moreover, instead of defining the basic processing of combining as combining processing of a total of two images, i.e., one reference image and one target image, it is easily possible to combine, for example, a total of four images, i.e., one reference image and three target images, by expanding the movement-information acquiring unit 104 and the combining processing unit 105. Furthermore, with this embodiment, a final combined image is generated from four images. However, it is not limited thereto, and a combined image may be generated from less than four or more than four images. Besides selecting an image acquired first, other possible ways to determine a reference image include: a method of selecting an image acquired later, and selecting an image acquired at an intermediate time by switching between first and second images every time the basic processing is carried out.

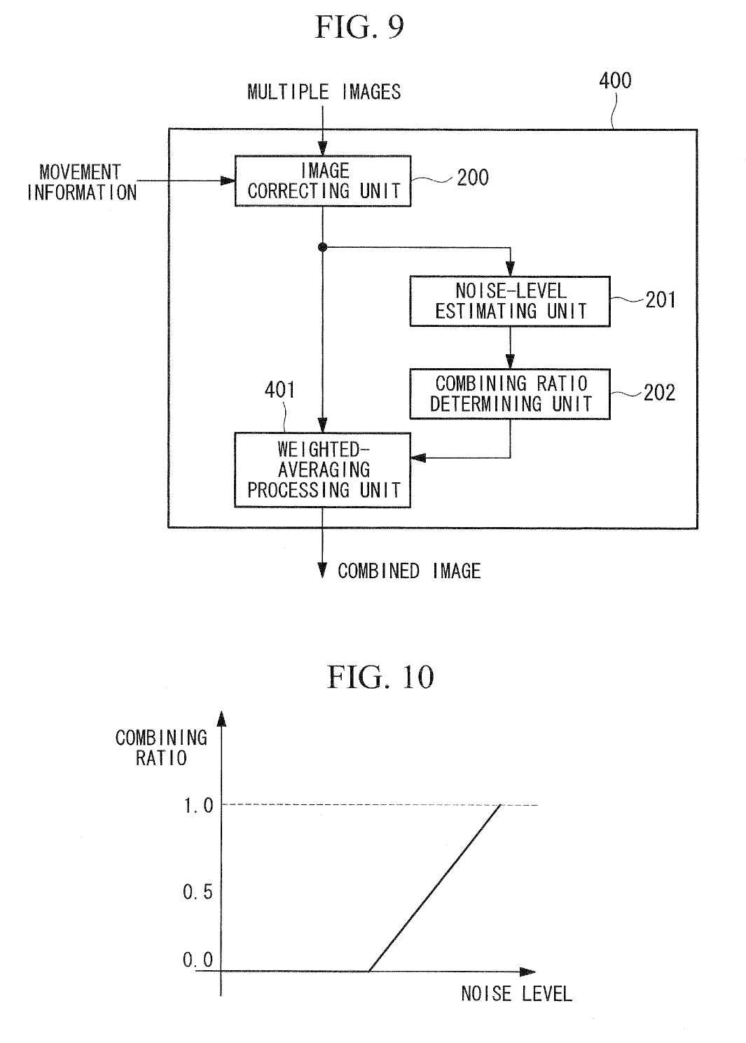

Next, a second embodiment of the present invention will be described. With the second embodiment, the configuration of the combining processing unit 105 according to the first embodiment is modified, but other configurations are the same as those of the first embodiment, and therefore, descriptions thereof are omitted. FIG. 9 is a block diagram illustrating, in outline, a combining processing unit 400 of the second embodiment.

The combining processing unit 400 of the second embodiment has a different configuration of the weighted-averaging processing unit in the combining processing unit 105 of the first embodiment, and is formed to reduce the amount of computation by not carrying out weighted averaging processing when the combining ratio of the target image is 0.0 at the combining ratio determining unit 202.

As illustrated in FIG. 10, when the combining ratio determining unit 202 uses a relationship in which the combining ratio is 0.0 in a region with a low noise level, for the pixels to be processed by a weighted-averaging processing unit 401, the pixels in the reference image are directly used as the pixels in the combined image, without carrying out weighted averaging processing. In this way, the amount of computation is reduced.

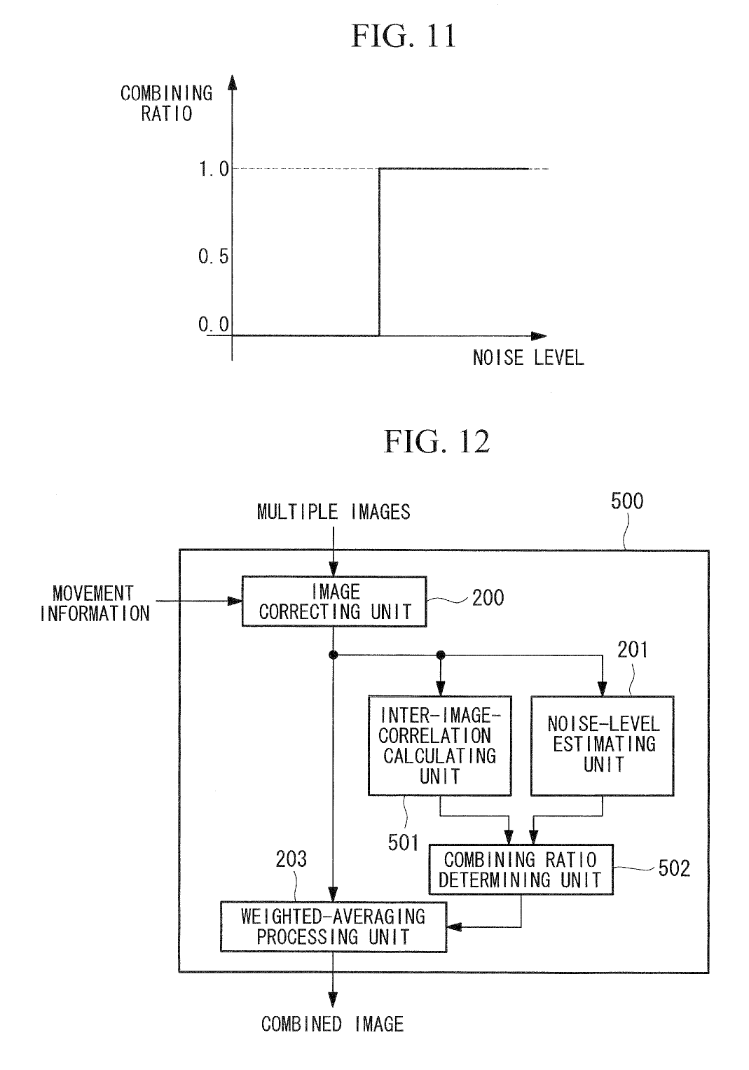

Furthermore, as illustrated in FIG. 11, it is also possible to employ a configuration in which the combining ratio used by the combining ratio determining unit 202 is fixed to two values, 0.0 and 1.0. In such a case, the combining ratio determining unit 202 selects either 0.0 or 1.0 for the combining ratio using a predetermined noise level as a threshold. As a result, the weighted-averaging processing unit 401 carries out weighted averaging processing on the pixels of the reference image and the pixels of the target image only when the combining ratio is 1.0; when the combining ratio is 0.0, weighted averaging processing is not carried out on the pixels.

As in this embodiment described above, by employing a configuration in which weighted averaging processing is not carried out when the combining ratio is 0.0, it is possible to reduce the amount of computation. Furthermore, by fixing the combining ratio to two values, 0.0 and 1.0, a configuration in which only the number of images to be combined is variable with respect to the noise level of each pixel or region becomes possible, and thus, it is possible to reduce the amount of computation.

Furthermore, a third embodiment of the present invention will be described. With the third embodiment, the configuration of the combining processing unit 105 according to the first embodiment is modified. A configuration diagram of a combining processing unit 500 according to the third embodiment is illustrated in FIG. 12.

With the third embodiment, an inter-image-correlation calculating unit 501 is added to the combining processing unit according to the first embodiment, and it is configured to more reliably suppress artifacts, such as fuzziness, a double image, etc., by determining the combining ratio at a combining ratio unit 502 on the basis of a correlation between the noise level and the images. Since other configurations are the same as those of the first embodiment, descriptions thereof are omitted.

The inter-image-correlation calculating unit 501 calculates, for each pixel, an absolute difference value as a correlation value between the reference image and the target image aligned by the image correcting unit 200. In general, when alignment is successful, the absolute difference value becomes small, whereas, when the alignment is unsuccessful, the absolute difference value becomes large; therefore, this result is used for controlling the combining ratio at the combining ratio unit 502 to suppress artifacts, such as fuzziness, a double image, etc, due to alignment failure.

With this embodiment, an absolute difference value is used as a correlation value. Instead, however, to calculate an even more stable correlation value, the sum of absolute difference (SAD) between blocks, which are constituted of pixels surrounding a target pixel, may be set as the correlation value. Furthermore, to reduce the amount of computation, instead of calculating a correlation value for each pixel, one correlation value may be calculated for each region formed of multiple pixels.

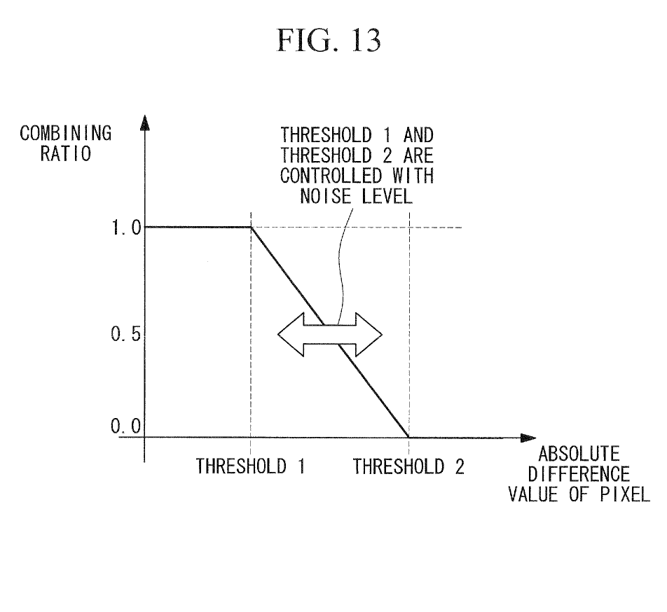

The combining ratio unit 502 determines the combining ratio of the reference image and the target image on the basis of the noise level calculated by the noise-level estimating unit 201 and the absolute difference value calculated by the inter-image-correlation calculating unit 501. FIG. 13 is a diagram illustrating the method of determining the combining ratio by the combining ratio unit 502. For the combining ratio, the combining percentage of the target image is represented by a value between 0.0 and 1.0 when the reference image is 1.0.

First, the combining ratio is controlled by the magnitude of the absolute difference value of a pixel. It is highly possible that alignment is successful when the absolute difference value is small, and thus, a high combining ratio is set. It is highly possible that alignment is unsuccessful when the absolute difference value is large, and thus, a low combining ratio is set to suppress artifacts. In the example in FIG. 13, thresholds 1 and 2 are defined; the combining ratio is set to 1.0 when the absolute difference value is smaller than the threshold 1, whereas the combining ratio is set to 0.0 when the absolute difference value is larger than the threshold 2; and the combining ratio is changes linearly from the threshold 1 to the threshold 2.

Here, the threshold 1 and the threshold 2 are defined depending on the noise level, and, similar to the first embodiment, the combining ratio is controlled in accordance with the noise level by controlling the threshold 1 and the threshold 2. Since the need to reduce noise in a pixel with a high noise level by combining is high, the threshold 1 and the threshold 2 are increased to increase the combining ratio. More specifically, for example, a value obtained by multiplying the noise level by a predetermined constant may be added to the threshold 1 and the threshold 2. Since the need to reduce noise by combining in a pixel with a low noise level is not high, the threshold 1 and the threshold 2 are decreased to decrease the combining ratio. More specifically, for example, a value obtained by multiplying the noise level by a predetermined constant may be subtracted from each of the threshold 1 and the threshold 2. The combining ratio unit 502 may provide this relationship by a method such as creating a table or may calculate this through equations.

Similar to the first embodiment, the weighted-averaging processing unit 203 carries out weighted averaging processing on the pixels in the reference image and the pixels in the target image in accordance with the combining ratio output from the combining ratio unit 502, and uses these as pixels in the combined image.

As described above, according to this embodiment, by calculating absolute difference values between pixels of images at the inter-image-correlation calculating unit, by estimating the noise levels of pixels that are targets of combining processing by the noise-level estimating unit, and, by controlling the combining ratio using both of these, it is possible to suppress artifacts caused by failure of the alignment processing or to suppress artifacts, such as the occurrence of fuzziness and/or a double image, due to excess combining processing carried out on pixels or regions with low levels of noise, and thus, a satisfactory combining result is achieved.

The above-described series of image processing for generating a combined image can be realized by hardware. Instead, however, it is also possible to realize it by software. In such a case, a program for executing the series of image processing as software is stored on a recording medium in advance, and predetermined processing can be executed by installing various programs for a computer integrated with predetermined hardware or a general-purpose personal computer.

What is claimed is:

1. An image processing apparatus configured to acquire multiple images of a subject by carrying out image acquisition of the subject and generate a combined image by combining the acquired multiple images, the apparatus comprising:
a noise-level estimating unit configured to estimate a noise level of each pixel or each predetermined region formed of multiple pixels in at least one image of the multiple images;
a combining ratio determining unit configured to determine, on the basis of the noise level, a combining ratio of a target image with respect to a reference image for each pixel or each region, when one of the multiple images is the reference image and the other images are target images; and
a combining unit configured to generate a combined image by combining the multiple images on the basis of the combining ratio.

2. The image processing apparatus according to claim 1, wherein the combining ratio determining unit sets a high value for the combining ratio when the noise level estimated by the noise-level estimating unit is high and sets a low value for the combining ratio when the noise level is low.

3. The image processing apparatus according to claim 1, wherein the combining ratio determining unit sets a combining percentage of the target image as the combining ratio when the reference image is defined as 1.0, sets the combining ratio to 0.0 when the noise level estimated by the noise-level estimating unit is less than a predetermined value, and sets the combining ratio to 1.0 when the noise level is greater than or equal to the predetermined value.

4. The image processing apparatus according to claim 1, further comprising:
a movement-information acquiring unit configured to acquire movement information among the multiple images; and
a correcting unit configured to correct the multiple images on the basis of the movement information,
wherein the noise-level estimating unit estimates, on the basis of the movement information, the noise level of each pixel or each predetermined region formed of multiple pixels in a corrected image.

5. The image processing apparatus according to claim 1, further comprising:
a correlation-amount calculating unit configured to compute a correlation amount between the reference image and at least one of the target images for each pixel or each predetermined region,
wherein the combining ratio determining unit sets a threshold corresponding to the noise level, compares the threshold and the correlation amount, and sets the combining ratio to smaller values as the correlation amount becomes smaller than the threshold.

6. The image processing apparatus according to claim 1, wherein the noise-level estimating unit estimates the noise level using a relationship between a pixel value acquired from at least one of a characteristic of an image acquisition device and a gradation conversion characteristic and an amount of noise in the pixel.

7. The image processing apparatus according to claim 1, wherein the noise-level estimating unit estimates the noise levels of pixels or regions that are in corresponding relationships among the multiple images used for combining and sets one of a maximum value, a minimum value, and a weighted average value of the estimated noise levels as a final noise level of the pixels or the regions.

8. The image processing apparatus according to claim 1, wherein the noise-level estimating unit estimates, on the basis of a representative value, the noise level of pixels or regions that are in corresponding relationships among the multiple images used for combining, the representative value being one of a pixel value, a maximum value, a minimum value, and a weighted average value of the pixels or the regions.

9. An image processing method of acquiring multiple images and generating a combined image by combining the acquired multiple images, the method comprising:
a noise-level estimating step of estimating a noise level of each pixel or each predetermined region formed of multiple pixels in at least one image of the multiple images;
a combining ratio determining step of determining, on the basis of the noise level, a combining ratio of a target image with respect to a reference image for each pixel or each region, when one of the multiple images is the reference image and the other images are target images; and
a combining step of generating a combined image by combining the multiple images on the basis of the combining ratio.

10. A program storage medium on which is stored an image processing program instructing a computer to execute image processing of acquiring multiple images and generating a combined image by combining the acquired multiple images, the image processing comprising:
a noise-level estimating step of estimating a noise level of each pixel or each predetermined region formed of multiple pixels in at least one image of the multiple images;
a combining ratio determining step of determining, on the basis of the noise level, a combining ratio of a target image with respect to a reference image for each pixel or the each region, when one of the multiple images is the reference image and the other images are target images; and
a combining step of generating a combined image by combining the multiple images on the basis of the combining ratio.
